(19) United States
(12) Patent Application Publication
(10) Pub. No.: US 2003/0195827 A1
(43) Pub. Date: Oct. 16, 2003

(54) Method of doing business involving conversion of traditional individual retirement account to a roth individual retirement account

(76) Inventor: Edwin Lichtig III, Lafayette, CA (US)

Correspondence Address: WILLIAM E. JOHNSON, JR., THE MATTHEWS FIRM, 1900 WEST LOOP SOUTH, SUITE 1800, HOUSTON, TX, 77027, US

(21) Appl. No.: 10/123,703

(22) Filed: Apr. 15, 2002

(51) Int. Cl. G06F 17/60

(52) U.S. Cl. 705/35

(57) ABSTRACT

A traditional IRA is first used to purchase an annuity, and then some months later, the traditional IRA is converted into a Roth IRA. Because of the penalty associated with the surrender of the annuity, the fair market value of the annuity transferred to the Roth IRA is discounted from the face value of the annuity, thus decreasing the federal income tax payable as a result of converting the traditional IRA to a Roth IRA. This method of doing business also contemplates the use of other assets similar in some ways to an annuity, such as long term real estate partnerships, that feature a long term surrender period, and an initial surrender penalty.

### TECHNICAL FIELD

This invention relates, generally, to methods for enhancing a retirement account, and specifically, to methods for converting an IRA to a Roth IRA.

### BACKGROUND OF THE INVENTION

As is well-known in the art, qualified contributions to Traditional Individual Retirement Accounts (“IRA”) are typically made with before tax dollars and are quite often deductible from the Adjustable Gross Income (“AGI”) a given year. Distribution to the owner of the IRA are then taxed as ordinary income, with a ten percent (10%) penalty if the owner is less than 591/2 years old.

Section 408 of the Internal Revenue Code created a Roth IRA commencing in 1997 which is funded with after tax dollars and which do not qualify as deductions from one's AGI. In sharp contrast with the traditional IRA, however, the distributions from the Roth IRA are never included in taxable income under the Internal Revenue Code, once the Roth IRA five (5) years holding period has expired.

It is also well-known in this art that a traditional IRA can be converted to a Roth IRA if the owner has an AGI of no more than $100,000. However, such a conversion typically creates a federal tax liability upon the dollar amount of the traditional IRA being converted. Some individuals have solved this problem, in part, by converting only in bits and pieces over the years to lessen the effect of the tax becoming payable all in a given year.

### OBJECTS OF THE INVENTION

It is therefore the primary object of the present invention to provide a new and improved method for converting a traditional IRA into a Roth IRA.

### BRIEF DESCRIPTION OF THE DRAWING

FIG. 1 illustrates a flow chart of the steps according to the invention for converting a traditional IRA into a Roth IRA.

FIG. 2 is a characteristic comparison of leaving assets in a traditional IRA versus those transferred from an IRA to a Roth IRA.

FIG. 3 is a chart of the declining penalties of a typical annuity over time.

### DETAILED DESCRIPTION OF THE PREFERRED EMBODIMENT OF THE INVENTION

As an initial step for a qualified IRA owner having an Adjusted Gross Income of no more than $100,000, the owner of the traditional IRA should have the traditional IRA purchase a $100,000 annuity having, for example, a twenty percent (20%) first year surrender charge. Thus, if the surrender value of the annuity is only $80,000 during the first year, that is the fair market value of the converted account.

During the first month of the owner's tax year, typically, January, and typically several months after the annuity is purchased, the annuity is transferred to a Roth IRA account. The annuity is not surrendered. The ownership of the annuity is merely changed to the Roth IRA account.

By way of further example, assume the traditional IRA purchase, the annuity in April of 2002, and the traditional IRA transfers the annuity to a Roth account in January of 2003. This typically creates a tax which is not payable until Apr. 15, 2004, about two (2) years from the date of the annuity being purchased. This two (2) year delay thus allows the conversion tax to be deferred.

As an additional feature of the invention, the custodian of the traditional IRA account will report the surrender value of the account as the taxable income, even though future income generated by the annuity will be based upon the undiscounted full amount of the annuity. With a twenty percent (20%) first year surrender charge, the fair market value of the annuity is thus $80,000 on the date of conversion. Assuming a twenty-eight percent (28%) tax bracket, there would be a $22,400 conversion tax.

Once the deferred tax becomes payable, the tax liability can be satisfied in various ways, for example, by:

a) withdrawing $22,400 from the Roth owned annuity, to pay the tax. This distribution, although not qualified under the Internal Revenue Code, typically is itself not a taxable event, even though the five (5) year holding period has not yet expired, because the $22,400 is deemed to be a part of the contribution and, the withdrawal does not come from earnings generated within the Roth account; or

b) withdraw the $22,400 from other funds; or

c) use a home equity loan to pay the tax; or

d) use a combination of two or more of these optional sources for paying the tax.

As an additional feature of the invention, one can have his or her traditional IRA purchase multiple annuities, each having, for example, a declining fifteen (15) year surrender charge. The owner can then transfer a single one of the annuities each year to the Roth IRA account and thus spread out the total conversion tax over those years. By way of further example, one can have his or her traditional IRA purchase three (3) annuities in April of 2002, 2003 and 2004, respectively. One of the three (3) annuities is transferred to the Roth account in January of 2003, one in January of 2004, and one in January of 2005, thus spreading out the tax liability until Apr. 15 of 2004, 2005 and 2006, respectively.

The Roth IRA can take the ownership of three (3) annuities in the first, second and third years, respectively, and still enable the annuities to be valued at their respective discounted amounts during the surrender periods.

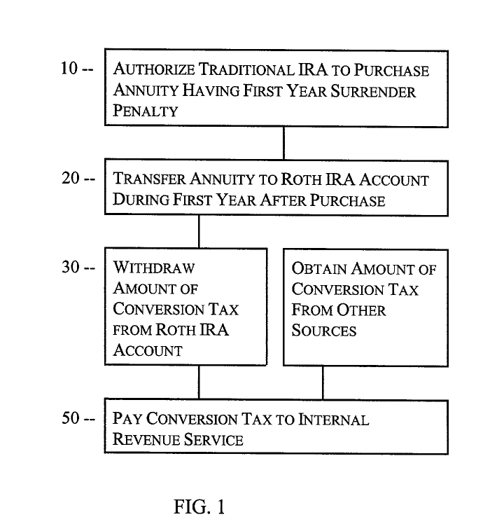

In summary, referring now to the flow chart illustrated in FIG. 1, and addressing only the purchase of a single annuity having a fifteen (15) year surrender period but having a higher first year surrender penalty, the box 10 indicates that the traditional IRA is authorized to purchase an annuity, for example, having a purchase price of $100,000 and a first year surrender value of $80,000. Within the first year, the annuity is transferred to a Roth IRA account, as illustrated in box 20, and having a fair market value of $80,000 (the surrender value). Approximately two (2) years later, the conversion tax payable to the IRS, illustrated in box 50, can be paid out of the annuity held by the Roth IRA (box 50) account, or from any other source of funds (box 40), such as from a loan, another financial account, etc.

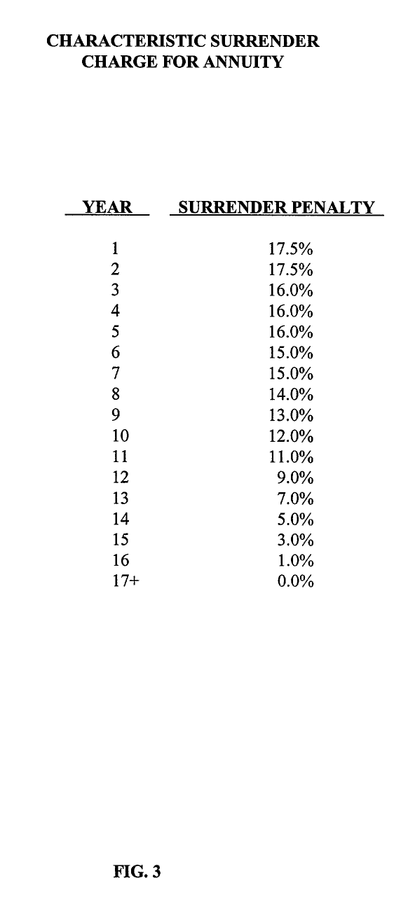

Annuities of this type will have a declining surrender penalty, typically 15-20% the first year, and declining each year, for 15-20 years, and having no penalty the last year or years of the period. Annuities typically have quite lengthy periods following purchase which generates a percentage penalty if the annuity is surrendered during such period. Although examples are presented herein of varying duration, for example, over a period of 15-20 years, and of varying first year surrender penalties of some 15-20%, the number of years and the percentage penalties will vary between the issuing companies. For example, in FIG. 3 there is illustrated one such annuity which has first and second year penalties of seventeen and one-half percent (17.5%) if surrendered, and the amount declines to zero percent (0%) in the 17th year following purchase of the annuity. The present invention contemplates, however, that whatever the penalty is for surrender in a given year for a given annuity, the fair market value which is subject to the conversion tax, is equal to the face value of the annuity minus the surrender penalty as if the annuity were surrendered on the date of such conversion.

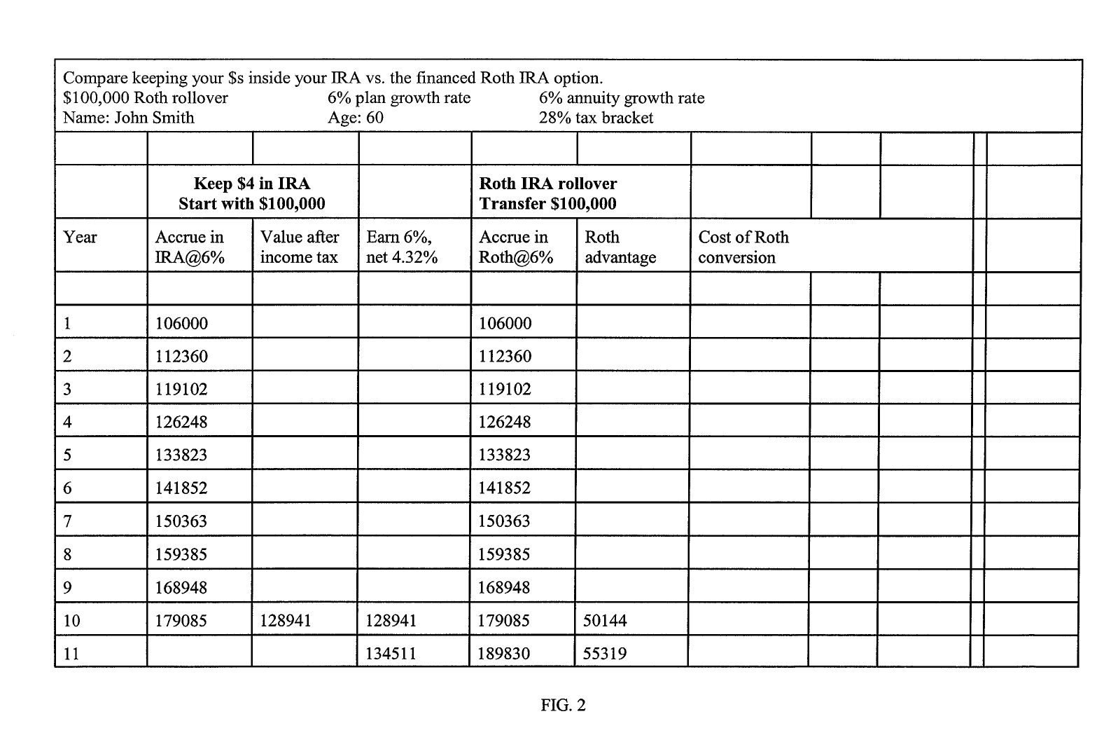

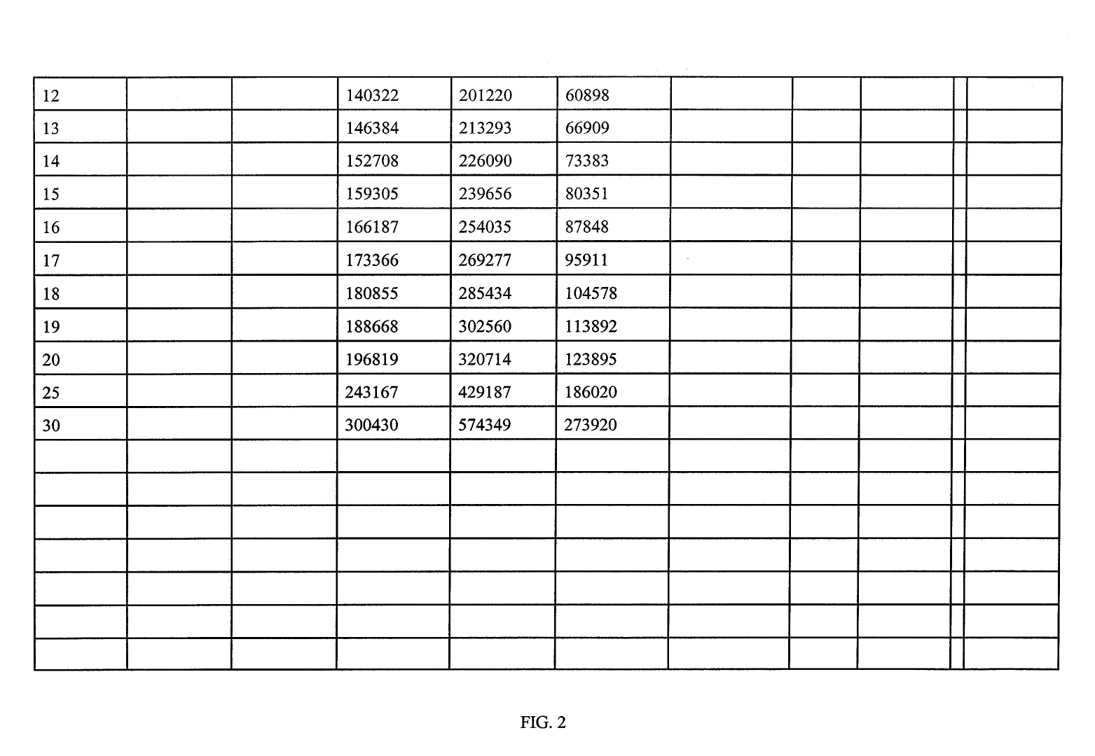

Referring now to FIG. 2, there is illustrated a characteristic comparison of leaving $100,000 inatraditional IRA account versus leaving $100,000 in a Roth IRA account, with each account having a six percent (6%) growth rate.

In addition to the monetary savings generated by the methods according to the present invention, there are numeral other features, including:

1) If one withdraws money from the traditional IRA, there is an increase in taxable income which may also increase the tax due on social security benefits. However, if one converts to a Roth IRA, and one subsequently takes tax free withdrawals, those withdrawals do not increase taxable income which may allow one to qualify for reduced or even tax free social security benefits. Hence the Roth IRA conversion may actually allow one to derive more after tax income from social security.

2) When a spouse dies, the tax bracket on the remaining spouse can increase dramatically. For example, a married couple faces a given federal tax on any taxable income above a given level but a single person faces an even higher federal tax on any taxable income above that same given level. If one converts to a Roth IRA, future Roth distributions are tax free regardless of the surviving spouse's tax bracket.

3) One can use any annuity, although an annuity with a high first year surrender charge may work in the owner's favor. The higher the first year surrender charge, the lower the reportable fair market value (surrender value).

4) One should consider using an equity indexed annuity with a fixed account. With the annual point to point products, one can switch strategies annually. One can opt for the fixed account (which is a declared rate for 12 months) or an equity indexed account. If one chooses the indexed account typically the potential gains or losses are limited. The worst that one can do is zero percent (0%) and the best is usually subject to a cap, for example, ten percent (10%). The equity indexed annuities are very appropriate for seniors in that the principal is never at risk.

5) One is left with a Roth IRA account growing tax free for up to three generations and thus provides the safety of an annuity that can provide a guarantee of principal, ideal for many seniors. The Roth IRA allows for tax free growth during the owner's life, the spouse's life, the children's and grandchildren's life, thus providing three (3) generations of tax free growth and tax free income.

6) The Roth IRA is a perfect source to cover large lump sum expenses, because the account can be liquidated without being taxed.

How to Maintain a Liquid Financial Position

Annuities face surrender penalties, just like certificates of deposit. A particular annuity features a 15 year surrender period. If one wants the tax discount, one must accept the surrender period. However, unlike a CD, this annuity allows for a ten percent (10%) annual withdrawal without penalty, making annual access possible. To derive maximum liquidity, consider implementing the following. . . .

1) Use part of the IRA balance for the conversion leaving the remaining IRA portion to meet current expenses. For example, if the client has $150,000 in their IRA account, consider transferring $100,000 to the Roth/annuity. This leaves $50,000, remaining inside the original IRA account, which can be accessed immediately and without surrender penalty.

2) Transfer ten percent (10%) per year from the Roth owned annuity to another Roth account. No tax is due when transferring from one Roth account to another. Take advantage of this option to build up another Roth account that does not face a surrender penalty. For example, assume your Roth IRA owns a $100,000 annuity. Assume the annuity earns five percent (5%). Hence the annuity grows to $105,000 by year end. Take $10,000 from the annuity (10% of the original contribution) and transfer the $10,000 to another Roth account invested in something that is completely liquid. At the end of the year you have $10,000 in one Roth account and $95,000 in the Roth owned annuity ($105,000-$10,000). Let's say you do this transfer every year for 5 years. If the annuity only earns five percent (5%) and yet 10% is transferred out each year, the annuity would shrink in value to about $75,000. The alternative Roth account, which has received the annual $10,000 transfers, may have grown to about $65,000. Just five years later about ½ half of the combined Roth accounts are completely liquid without a surrender penalty.

3) At the end of the surrender period, the entire balance can be transferred into anything without a surrender penalty.

The present invention is a departure from the usual mode of converting a traditional IRA account into a Roth IRA account. Because of this departure from the conventional method of conversion, there is an education process involved which includes teaching and educating the traditional IRA custodian to report the surrender value of the annuity as the reportable value on the IRS 1099R form. This form is generated by the traditional IRA custodian when there is a distribution from an IRA account. There are apparently no reported instances in which custodians of traditional IRA accounts have reported, previously, the surrender value of the annuity as the taxable value on the 1099R form.

There is also the education process involved in which the custodian is educated to report the surrender value of the annuity as the reportable value from the IRS 5498 form, a year-end report which is filed with respect to IRA accounts showing the value in the account. This is of course consistent with the reporting by the custodian with a 1099R form.

There is also the education process of the financial planners to complete the annuity application such that the owner of the application is the bank custodian.

It is also desirable to educate third party appraisers to value the annuity if necessary or otherwise desirable, because assets such as annuities must be reported at fair market value when distributed from qualified plans.

The invention as described heretofore has primarily been involved with using a purchased annuity as an asset in the traditional IRA and then transferring the asset in the traditional IRA into a Roth IRA account and using the surrender value of the annuity as the fair market value. It should be appreciated, however, that other assets can be used instead of using an annuity. For example, those people who are active in this market will from time to time develop a product similar to an annuity, for example, such as a long term real estate partnership, that features a long term surrender period and an initial surrender penalty. This present invention is intended to cover any such plan which can be transferred from a traditional IRA account into a Roth IRA account during the surrender period to allow the surrender value to be reported as the fair market value of the asset.

1. A method for converting a traditional IRA into a Roth IRA, comprising:
a) using a traditional IRA to purchase an annuity of a given face value, and having a declining surrender penalty for a given number of years; and
b) converting the said traditional IRA having said annuity as its asset to a Roth IRA, wherein said annuity has a fair market value discounted from said given face value on the date of such conversion.

2. The method according to claim 1, wherein the fair market value of the said annuity is equal to the said given face value minus the surrender penalty of said annuity if surrendered in the year of such conversion.

3. The method according to claim 2, wherein the dollar amount of the said surrender penalty decreases as a function of time.

4. A method for converting a plurality of traditional IRA's to Roth IRA's, comprising
a) using a traditional IRA to purchase a plurality of annuities, each of said annuities having a given face value and each having a declining surrender penalty for a given number of years;
b) converting said traditional IRA's to Roth IRA's, wherein each of said annuities has a given fair market value, respectively, discounted from the respective face values of said annuities on the respective dates of said conversions.

5. A method for converting a traditional IRA into a Roth IRA, comprising:
a) using a traditional IRA to purchase an asset of a given face value, and having a declining surrender penalty for a given number of years; and
b) converting the said traditional IRA having said asset to a Roth IRA, wherein said asset has a fair market value discounted from said given face value on the date of such conversion.

6. The method according to claim 5, wherein the fair market value of the said asset is equal to the said given face value minus the surrender penalty of said asset if surrendered in the year of such conversion.

7. The method according to claim 6, wherein the dollar amount of the said surrender penalty decreases as a function of time.

8. The method according to claim 5, wherein said asset comprises a real estate partnership.
